(19) United States
(12) Patent Application Publication
(10) Pub. No.: US 2014/0090388 A1
(43) Pub. Date: Apr. 3, 2014

(54) OFF-TAKE POWER RATIO

(71) Applicant: United Technologies Corporation, (US)

(72) Inventor: Karl L. Hasel, Manchester, CT (US)

(73) Assignee: UNITED TECHNOLOGIES CORPORATION, Hartford, CT (US)

(21) Appl. No.: 13/716,468

(22) Filed: Dec. 17, 2012

Related U.S. Application Data
(60) Provisional application No. 61/707,322, filed on Sep. 28, 2012.

(51) Int. Cl. F02C 3/113; F02C 7/36; F02C 3/04

(52) U.S. Cl. CPC F02C 3/113; F02C 3/04; F02C 7/36
USPC 60/772; 60/792; 60/793; 60/802; 60/39.45

(57) ABSTRACT

An example method of allocating power within a gas turbine engine includes driving an off-take power delivery assembly using a first amount of power from a spool, the first amount of power corresponding to an off-take power requirement of a gas turbine engine; and driving the spool of the gas turbine engine using a second amount of power, wherein a ratio of the first amount of power to the second amount of power is greater than or equal to 0.009.

### CROSS-REFERENCE TO RELATED APPLICATIONS

This application claims priority to U.S. Provisional Application No. 61/707322, which was filed on 28 Sep. 2012 and is incorporated herein by reference.

### BACKGROUND

A gas turbine engine typically includes a fan section, a compressor section, a combustor section, and a turbine section. Air entering the compressor section is compressed and delivered into the combustor section where it is mixed with fuel and ignited to generate a high temperature gas flow. The high temperature gas flow expands through the turbine section to drive the compressor and the fan section. The compressor section typically includes low and high pressure compressors, and the turbine section includes low and high pressure turbines.

The high pressure turbine drives the high pressure compressor through an outer shaft to form a high spool, and the low pressure turbine drives the low pressure compressor through an inner shaft to form a low spool. The fan section may also be driven by the low inner shaft. A direct drive gas turbine engine includes a fan section driven by the low spool such that the low pressure compressor, low pressure turbine and fan section rotate at a common speed in a common direction.

A speed reduction device such as an epicyclical gear assembly may be utilized to drive the fan section such that the fan section may rotate at a speed different than the turbine section so as to increase the overall propulsive efficiency of the engine. In such engine architectures, a shaft driven by one of the turbine sections provides an input to the epicyclical gear assembly that drives the fan section at a reduced speed such that both the turbine section and the fan section can rotate at closer to optimal speeds.

Although geared architectures have improved propulsive efficiency, turbine engine manufacturers continue to seek further improvements to engine performance including improvements to thermal, transfer, and propulsive efficiencies. As known, aircraft manufacturers often specify an amount of power required from the engine to power accessory aircraft systems, such as environmental control systems and electrical systems.

### SUMMARY

A method of allocating power within a gas turbine engine according to an exemplary aspect of the present disclosure includes, among other things, driving an off-take power delivery assembly using a first amount of power from a spool, the first amount of power corresponding to an off-take power requirement of a gas turbine engine. The method further includes driving the spool of the gas turbine engine using a second amount of power. A ratio of the first amount of power to the second amount of power is greater than or equal to 0.009.

In a further non-limiting embodiment of the foregoing method of allocating power, the off-take power delivery assembly may comprise an accessory gearbox.

In a further non-limiting embodiment of the either of the foregoing methods of allocating power, the method may include rotating a tower shaft with the spool to provide power to the accessory gearbox.

In a further non-limiting embodiment of any of the foregoing methods of allocating power, the accessory gearbox may rotatably drive a generator to provide power to non-engine accessories using the first amount of power.

In a further non-limiting embodiment of any of the foregoing methods of allocating power, the off-take power requirement may correspond to the gas turbine engine operating at an engine operating condition. The spool may be configured to be driven using the second amount of power when the gas turbine engine is operating at the engine operating condition.

In a further non-limiting embodiment of any of the foregoing methods of allocating power, the spool may be a high speed spool and the gas turbine engine may further comprises a low speed spool. The high speed spool may be configured to rotate at higher speeds relative to the low speed spool during operation.

In a further non-limiting embodiment of any of the foregoing methods of allocating power, the method may include delivering the first amount of power to non-engine accessories.

A gas turbine engine according to another exemplary aspect of the present disclosure includes, among other things, a fan including a plurality of fan blades rotatable about an axis; a compressor section; a combustor in fluid communication with the compressor section; a turbine section in fluid communication with the combustor; a geared architecture driven by the turbine section for rotating the fan about the axis; and an accessory gearbox configured to provide a first amount of power corresponding to an off-take power requirement of a gas turbine engine when the accessory gearbox is driven by a spool that is rotated using a second amount of power. A ratio of the first amount of power to the second amount of power is greater than or equal to about 0.009.

In a further non-limiting embodiment of the foregoing gas turbine engine, the off-take power requirement may correspond to the gas turbine engine operating at an engine operating condition, and the accessory gearbox may be configured to be driven by the spool that is rotated using the second amount of power when the engine is operating at the engine operating condition.

In a further non-limiting embodiment of either of foregoing gas turbine engines, a tower shaft may rotatably couple the spool to the accessory gearbox.

In a further non-limiting embodiment of any of foregoing gas turbine engines, a generator may be configured to be driven by the accessory gearbox to provide power to non-engine accessories.

In a further non-limiting embodiment of any of foregoing gas turbine engines, the spool may be a high speed spool and the gas turbine engine may further comprise a low speed spool. The high speed spool may be configured to rotate at higher speeds relative to the low speed spool during operation.

A gas turbine engine according to yet another exemplary aspect of the present disclosure includes an off-take power delivery assembly configured to be driven by a spool using a first amount of power. The first amount of power corresponds to an off-take power requirement of a gas turbine engine. The spool is configured to be driven using a second amount of power. A ratio of the first amount of power to the second amount of power is greater than or equal to 0.009.

In a further non-limiting embodiment of the foregoing gas turbine engine, the off-take power delivery assembly may comprises an accessory gearbox.

In a further non-limiting embodiment of either of foregoing gas turbine engines, the off-take power delivery assembly may comprise a tower shaft operatively coupling the accessory gearbox to the spool.

In a further non-limiting embodiment of any of foregoing gas turbine engines, the accessory gearbox may be configured to rotatably drive a generator to provide power to a plurality of non-engine accessories.

In a further non-limiting embodiment of any of foregoing gas turbine engines, the off-take power requirement may correspond to the gas turbine engine operating at an engine operating condition, and the spool may be configured to be driven using the first amount of power when the engine is operating at the engine operating condition.

In a further non-limiting embodiment of any of foregoing gas turbine engines, the spool may be a high speed spool and the gas turbine engine may further comprise a low speed spool. The high speed spool may be configured to rotate at higher speeds relative to the low speed spool during operation.

Although the different examples have the specific components shown in the illustrations, embodiments of this disclosure are not limited to those particular combinations. It is possible to use some of the components or features from one of the examples in combination with features or components from another one of the examples.

### BRIEF DESCRIPTION OF THE DRAWINGS

The various features and advantages of the disclosed examples will become apparent to those skilled in the art from the detailed description. The figures that accompany the detailed description can be briefly described as follows:

FIG. 1 shows a section view of an example gas turbine engine.

FIG. 2 shows a section view of a variation of the gas turbine engine of FIG. 1.

### DETAILED DESCRIPTION

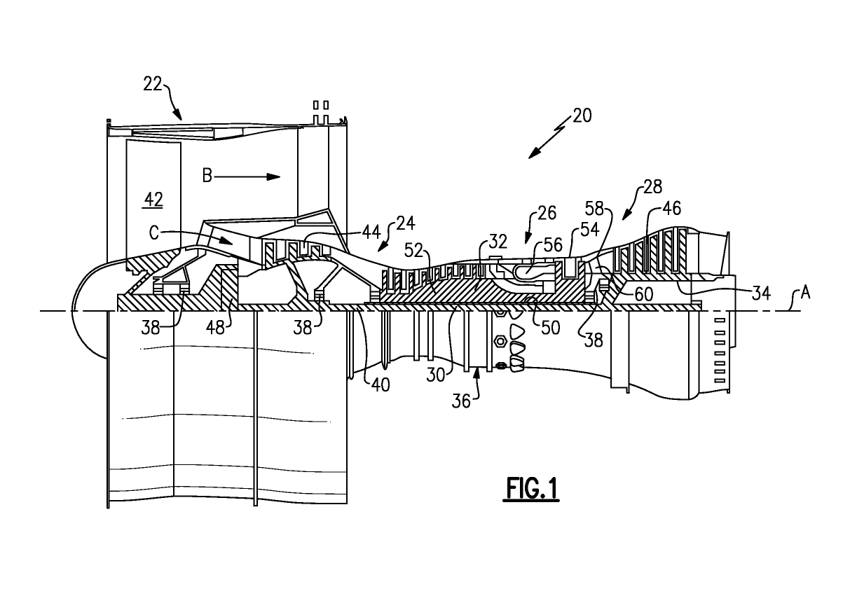

FIG. 1 schematically illustrates an example gas turbine engine 20 that includes a fan section 22, a compressor section 24, a combustor section 26, and a turbine section 28. Alternative engines might include an augmenter section (not shown) among other systems or features. The fan section 22 drives air along a bypass flow path B while the compressor section 24 draws air in along a core flow path C where air is compressed and communicated to a combustor section 26. In the combustor section 26, air is mixed with fuel and ignited to generate a high temperature gas stream that expands through the turbine section 28 where energy is extracted and utilized to drive the fan section 22 and the compressor section 24.

Although the disclosed non-limiting embodiment depicts a turbofan gas turbine engine, it should be understood that the concepts described herein are not limited to use with turbofans as the teachings may be applied to other types of turbine engines; for example a turbine engine including a three-spool architecture in which three spools concentrically rotate about a common axis and where a low spool enables a low pressure turbine to drive a fan via a gearbox, an intermediate spool that enables an intermediate pressure turbine to drive a first compressor of the compressor section, and a high spool that enables a high pressure turbine to drive a high pressure compressor of the compressor section.

The example engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided.

The low speed spool 30 generally includes an inner shaft 40 that connects a fan 42 and a low pressure (or first) compressor section 44 to a low pressure (or first) turbine section 46. The inner shaft 40 drives the fan 42 through a speed change device, such as a geared architecture 48, to drive the fan 42 at a lower speed than the low speed spool 30. The high speed spool 32 includes an outer shaft 50 that interconnects a high pressure (or second) compressor section 52 and a high pressure (or second) turbine section 54. The inner shaft 40 and the outer shaft 50 are concentric and rotate via the bearing systems 38 about the engine central longitudinal axis A.

A combustor 56 is arranged between the high pressure compressor 52 and the high pressure turbine 54. In one example, the high pressure turbine 54 includes at least two stages to provide a double stage high pressure turbine 54. In another example, the high pressure turbine 54 includes only a single stage. As used herein, a “high pressure” compressor or turbine experiences a higher pressure than a corresponding “low pressure” compressor or turbine.

The example low pressure turbine 46 has a pressure ratio that is greater than about 5. The pressure ratio of the example low pressure turbine 46 is measured prior to an inlet of the low pressure turbine 46 as related to the pressure measured at the outlet of the low pressure turbine 46 prior to an exhaust nozzle.

A mid-turbine frame 58 of the engine static structure 36 is arranged generally between the high pressure turbine 54 and the low pressure turbine 46. The mid-turbine frame 58 further supports bearing systems 38 in the turbine section 28 as well as setting airflow entering the low pressure turbine 46.

The core airflow C is compressed by the low pressure compressor 44 then by the high pressure compressor 52 mixed with fuel and ignited in the combustor 56 to produce high temperature gases that are then expanded through the high pressure turbine 54 and low pressure turbine 46. The mid-turbine frame 58 may include vanes 60, which are in the core airflow path and function as an inlet guide vane for the low pressure turbine 46. Utilizing the vane 60 of the mid-turbine frame 58 as the inlet guide vane for low pressure turbine 46 decreases the length of the low pressure turbine 46 without increasing the axial length of the mid-turbine frame 58. Reducing or eliminating the number of vanes in the low pressure turbine 46 shortens the axial length of the turbine section 28. Thus, the compactness of the gas turbine engine 20 is increased and a higher power density may be achieved.

The disclosed gas turbine engine 20 in one example is a high-bypass geared aircraft engine. In a further example, the gas turbine engine 20 includes a bypass ratio greater than about six (6), with an example embodiment being greater than about ten (10). The example geared architecture 48 is an epicyclical gear train, such as a planetary gear system, star gear system or other known gear system, with a gear reduction ratio of greater than about 2.3.

In one disclosed embodiment, the gas turbine engine 20 includes a bypass ratio greater than about ten (10:1) and the fan diameter is significantly larger than an outer diameter of the low pressure compressor 44. It should be understood, however, that the above parameters are only exemplary of one embodiment of a gas turbine engine including a geared architecture and that the present disclosure is applicable to other gas turbine engines.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft., with the engine at its best fuel consumption—also known as “bucket cruise Thrust Specific Fuel Consumption (‘TSFC’)”—is the industry standard parameter of pound-mass (lbm) of fuel per hour being burned divided by pound-force (lbf) of thrust the engine produces at that minimum point.

“Low fan pressure ratio” is the pressure ratio across the fan blade alone, without a Fan Exit Guide Vane (“FEGV”) system. The low fan pressure ratio as disclosed herein according to one non-limiting embodiment is less than about 1.50. In another non-limiting embodiment the low fan pressure ratio is less than about 1.45.

“Low corrected fan tip speed” is the actual fan tip speed in ft/sec divided by an industry standard temperature correction of [(Tram° R)/(518.7° R)]^{0.5}. The “Low corrected fan tip speed,” as disclosed herein according to one non-limiting embodiment, is less than about 1150 ft/second.

The example gas turbine engine includes the fan 42 that comprises in one non-limiting embodiment less than about 26 fan blades. In another non-limiting embodiment, the fan section 22 includes less than about 20 fan blades. Moreover, in one disclosed embodiment the low pressure turbine 46 includes no more than about 6 turbine rotors schematically indicated at 34. In another non-limiting example embodiment the low pressure turbine 46 includes about 3 turbine rotors. A ratio between the number of fan blades and the number of low pressure turbine rotors is between about 3.3 and about 8.6. The example low pressure turbine 46 provides the driving power to rotate the fan section 22 and therefore the relationship between the number of turbine rotors 34 in the low pressure turbine 46 and the number of blades in the fan section 22 disclose an example gas turbine engine 20 with increased power transfer efficiency.

As known, not all power generated by gas turbine engines is used by the engine for propulsion or for engine accessories. Typically, some of the power generated by gas turbine engines is siphoned off and used to power non-engine accessory systems of an associated aircraft. Example non-engine accessory systems include environmental control systems and electrical systems of the aircraft.

Power from gas turbine engines that is used for the non-engine accessory systems is often referred to as “off-take power.” The off-take power is in addition to the power generated by the engine that provides propulsive thrust. The off-take power is also in addition to the power required to drive engine oil pumps, engine generators, or other engine operating systems.

As also known, airframe manufacturers (Boeing, Airbus, etc.) often require engines to deliver a specific amount of off-take power. The specified off-take power from the engine can be referred to as an engine's off-take power requirement. The off-take power is set at a level that will ensure that the engine will be able to deliver adequate levels of off-take power to non-engine accessory components. The off-take power requirements are typically defined at several engine operating conditions, such as at 35,000 feet 0.80 Mach number cruise-thrust power and maximum climb-thrust power, and at sea level static takeoff-thrust power.

Notably, during engine operation, the engine may deliver the power at a level other than that which meets or exceeds the off-take power requirement, at the pre-defined required conditions. However, the engine must be capable of delivering power at a level that meets or exceeds the off-take power requirement required by the non-engine accessory systems at any aircraft operating flight condition or engine power setting.

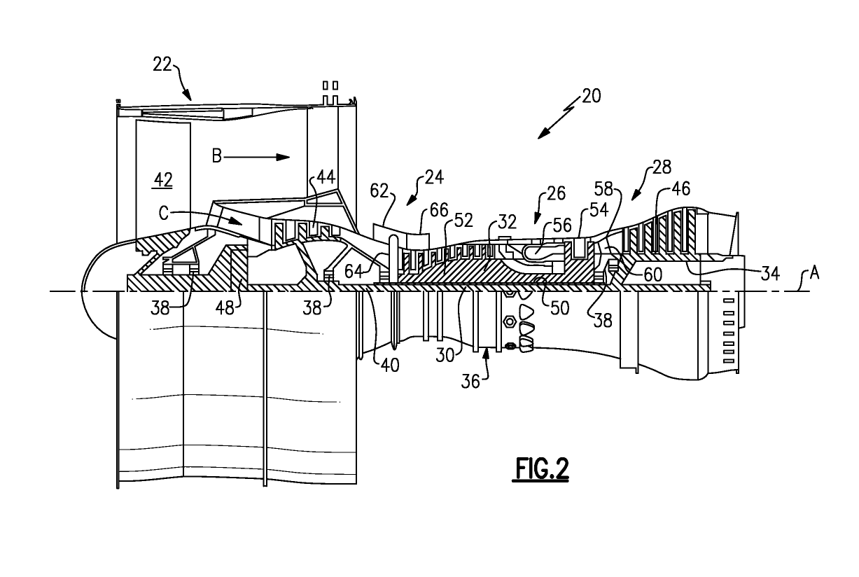

Referring now to FIG. 2, an engine 20a is an example variation of the engine 20. A bypass ratio of the example engine 20a is greater than about 8, and a fan drive gear ratio of the example engine 20a is from 2.4 to 4.2. The engine 20a includes a tower shaft 64 driven by the outer shaft 50 of the high speed spool 32. The tower shaft 64 drives an accessory gearbox 62 that in turn drives an accessory generator 66 to provide off-take power from the engine 20a. The off-take power from the accessory generator 66 may be used to power aircraft systems, such as the environmental control systems and electrical systems

The tower shaft 64 and the accessory gearbox 62 are example off-take power delivery assemblies. Other types of off-take power delivery assemblies are possible. For example, hydraulic pumps and other devices not associated directly with operation of the gas turbine engine 20 may be utilized to extract off-take power from the high speed spool 32. These devices convert the off-take power to be used by other non-engine accessories.

The engine 20a has an associated off-take power requirement that is expressed in horsepower, for example. Adjustments are made to the tower shaft 64, the accessory gearbox 62, etc., to ensure that the off-take power from the generator 66 meets the off-take power requirement. In this example, to meet the off-take power requirement, the off-take power must meet or exceed the off-take power requirement at a given engine operating condition.

In this example, a ratio of this off-take power requirement to the power driving the high pressure compressor 52 (at the engine operating condition of 35000 FT, 0.80 Mn flight speed, and cruise thrust power) is greater than or equal to about 0.009. In one more specific example, the ratio of the off-take power requirement to the power driving the high pressure compressor 52 is 0.0094.

A person having skill in this art and the benefit of this disclosure would be able to determine the power used to drive the high pressure compressor 52 given an engine operating condition. This skilled person would utilize compressor efficiency, airflow, and pressure ratio through the compressor, for example.

The off-take power requirement may be considered a first amount of power, and the power driving the high pressure compressor 52 a second amount of power. In some prior art engines, a ratio of these powers (first/second) is between about 0.004 and about 0.0084.

Although example embodiments have been disclosed, a worker of ordinary skill in this art would recognize that certain modifications would come within the scope of this disclosure. For that reason, the following claims should be studied to determine the scope and content of this disclosure.

I claim:

1. A method of allocating power within a gas turbine engine, comprising:
driving an off-take power delivery assembly using a first amount of power from a spool, the first amount of power corresponding to an off-take power requirement of a gas turbine engine; and
driving the spool of the gas turbine engine using a second amount of power, wherein a ratio of the first amount of power to the second amount of power is greater than or equal to 0.009.

2. The method of claim 1, wherein the off-take power delivery assembly comprises an accessory gearbox.

3. The method of claim 2, including rotating a tower shaft with the spool to provide power to the accessory gearbox.

4. The method of claim 2, wherein the accessory gearbox rotatably drives a generator to provide power to non-engine accessories using the first amount of power.

5. The method of claim 1, wherein the off-take power requirement corresponds to the gas turbine engine operating at an engine operating condition, and the spool is configured to be driven using the second amount of power when the gas turbine engine is operating at the engine operating condition.

6. The method of claim 1, wherein the spool is a high speed spool and the gas turbine engine further comprises a low speed spool, wherein the high speed spool is configured to rotate at higher speeds relative to the low speed spool during operation.

7. The method of claim 1, including delivering the first amount of power to non-engine accessories.

8. A gas turbine engine comprising:
a fan including a plurality of fan blades rotatable about an axis;
a compressor section;
a combustor in fluid communication with the compressor section;
a turbine section in fluid communication with the combustor;
a geared architecture driven by the turbine section for rotating the fan about the axis; and
an accessory gearbox configured to provide a first amount of power corresponding to an off-take power requirement of a gas turbine engine when the accessory gearbox is driven by a spool that is rotated using a second amount of power, wherein a ratio of the first amount of power to the second amount of power is greater than or equal to about 0.009.

9. The gas turbine engine of claim 8, wherein the off-take power requirement corresponds to the gas turbine engine operating at an engine operating condition, and the accessory gearbox is configured to be driven by the spool that is rotated using the second amount of power when the engine is operating at the engine operating condition.

10. The gas turbine engine of claim 8, including a tower shaft that rotatably couples the spool to the accessory gearbox.

11. The gas turbine engine of claim 8, including a generator configured to be driven by the accessory gearbox to provide power to non-engine accessories.

12. The gas turbine engine of claim 8, wherein the spool is a high speed spool and the gas turbine engine further comprises a low speed spool, wherein the high speed spool is configured to rotate at higher speeds relative to the low speed spool during operation.

13. A gas turbine engine, comprising:
an off-take power delivery assembly configured to be driven by a spool using a first amount of power, the first amount of power corresponding to an off-take power requirement of a gas turbine engine, the spool configured to be driven using a second amount of power, wherein a ratio of the first amount of power to the second amount of power is greater than or equal to 0.009.

14. The gas turbine engine of claim 13, wherein the off-take power delivery assembly comprises an accessory gearbox.

15. The gas turbine engine of claim 14, wherein the off-take power delivery assembly comprises a tower shaft operatively coupling the accessory gearbox to the spool.

16. The gas turbine engine of claim 15, wherein the accessory gearbox is configured to rotatably drive a generator to provide power to a plurality of non-engine accessories.

17. The gas turbine engine of claim 14, wherein the off-take power requirement corresponds to the gas turbine engine operating at an engine operating condition, and the spool is configured to be driven using the first amount of power when the engine is operating at the engine operating condition.

18. The gas turbine engine of claim 14, wherein the spool is a high speed spool and the gas turbine engine further comprises a low speed spool, wherein the high speed spool is configured to rotate at higher speeds relative to the low speed spool during operation.
